(19) United States
(12) Patent Application Publication
(10) Pub. No.: US 2002/0138561 A1
(43) Pub. Date: Sep. 26, 2002

(54) System, method, and computer program product for an end-user of an open access network to select a new service provider following a discontinuance of a business relationship between their current service provider and the operator of the open access network

(75) Inventors: Terrance Chatfield, Ashburn, VA (US); Ronald K. Dobes, Potomac Falls, VA (US); Eugene L. Lew, Olney, MD (US); Michael Handler, Washington, DC (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: GEMINI NETWORKS, INC., Falls Church, VA

(21) Appl. No.: 10/075,233

(22) Filed: Feb. 15, 2002

Related U.S. Application Data
(60) Provisional application No. 60/268,896, filed on Feb. 16, 2001.

(51) Int. Cl. G06F 15/16

(52) U.S. Cl. 709/203

(57) ABSTRACT

A system, method, and computer program product for an end-user of an open access high-speed network for providing broadband data transport services to select a new service provider as a replacement for a current service provider that is no longer a customer of an operator of a high-speed network providing connectivity between end-users and a plurality of service providers providing services on a common network such as the Internet. A digital repository is populated with information regarding the end-users and their service providers. End-users subscribing to a discontinued service provider are redirected to a service provider selection user interface upon accessing the open access high-speed network.

### CROSS REFERENCE TO RELATED PATENT DOCUMENTS

The present document contains subject matter related to that disclosed in commonly owned, co-pending application Ser. No. 09/784,074 filed Feb. 16, 2001, entitled SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM (Attorney Docket No. 200876US-8); application Ser. No. 09/784,075 filed Feb. 16, 2001, entitled “SYSTEM, METHOD, AND COMPUTER PROGRAM PRODUCT FOR END-USER SELF-AUTHENTICATION” (Attorney Docket No. 202585US-8); and Provisional Application Serial No. 60/268,896 filed Feb. 16, 2001, entitled SYSTEM, METHOD, AND COMPUTER PROGRAM PRODUCT FOR ENDUSER SERVICE PROVIDER SELECTION (Attorney Docket No. 202664US-8 PROV), the entire contents of each of which being incorporated herein by reference.

### BACKGROUND OF THE INVENTION

1. Field of the Invention

The present invention relates to open access high-speed networks, and in particular to systems, methods, and computer program products for an end-user to select a new service provider following a discontinuance of a business relationship between their current service provider and the operator of the open access network.

2. Discussion of the Background

An end-user gains access to the Internet by contacting an Internet service provider (ISP). If the end-user is satisfied with the services provided by the ISP, and the price for which those services are offered, the end-user enters into a subscription contract with that ISP. For dial-up access to the Internet, the end-user will use a modem to place a call over the existing telephone network in order to gain connectivity to the ISP. The ISP provides access to the Internet via the ISP's connection to a backbone network provided by a backbone provider (e.g., UUNET). The ISP provides certain services to the end-user, including, for example, e-mail, news, and download capability. The services provided by the various ISPs do not vary substantially. In general, end-users view ISPs as a necessary conduit between them and the Internet, as well as a provider of a minimal set of necessary services.

A Digital Subscriber Line (DSL) connection to the Internet provides a higher speed connection than the dial-up connection discussed above. An end-user connects to a DSL line via a DSL modem to gain connectivity to a DSL ISP. As with the dial-up connection, the ISP provides connectivity to the Internet via the backbone. As with the dial-up situation, the end-user looks to the ISP for providing connectivity to the Internet, albeit in this case via a higher speed DSL connection, and also to provide the same minimal set of services, including, for example, e-mail. An end-user typically has fewer ISPs to select from for providing DSL connectivity. This is due to the fact that not all ISPs have access to DSL lines running between the ISP and the end-users. End-users will typically subscribe to the DSL ISP that provides the services required by the end-user at the best price. In the DSL context, it is possible that the ISP is able to provide DSL access to the Internet through a contractual relationship between the ISP and the owner of the DSL network, for example, a telephone company. In this situation, the end-user's contract with the ISP may be impacted by a change in the relationship between the ISP and the owner of the DSL network.

Another way of gaining higher speed connectivity to the Internet is by connecting the end-user to the ISP via a cable television (CATV) network. In this example, oftentimes the cable television service provider serves as the ISP and provides the end-user with a cable modem through which the end-user can connect to the cable television provider. As with the other examples, the cable television provider then provides connectivity to the Internet via a connection to a backbone provided by a backbone provider. In this scenario, the end-user enters into a separate subscription contract with the cable television company for the ISP services. Again, the ISP (i.e., the cable television company) provides the minimal set of required services including, for example, email.

Similar to the situation where an ISP has a contractual relationship with the owner of a DSL network, an ISP may have a contractual relationship with the owner of a CATV network. For example, Road Runner is an ISP that offers high-speed connectivity to the Internet, through the existing CATV networks by entering into contractual relationships with those CATV network owners. In this arrangement, Road Runner provides a cable modem to the end-users and connectivity to the CATV network, and routes the end-users to Road Runner via the CATV network. As with the other ISPs discussed above, Road Runner then provides connectivity to the Internet through a backbone provided by a backbone provider. End-users desiring this type of connection enter into a subscription contract with, in this example, Road Runner to gain the high-speed connection and the ISP services including, for example, email. As with the third party DSL ISP, should the contractual relationship between the CATV network owner and the third party ISP (e.g., Road Runner) be severed, the contract between the end-user and the ISP would be unable to be performed since the ISP would no longer have access to the CATV network. A similar situation would result in a situation where the ISP goes out of business.

Various approaches for connecting to the Internet, including via DSL connections and cable modem connections, are described in White, R., “How Computers Work,” Que, September 1999, and Gralla, P. “How the Internet Works,” Que, August 1999, the entire contents of both of which are incorporated herein by reference.

While dealing directly with the owner of the network (e.g., a telephone company or a cable television company) may be less risky than dealing with a third party ISP that relies on a contract with a network owner, the end-user nonetheless bears the risk that the network owner may decide to exit the ISP business. Of course, the primary business of these network owners is for providing telephone service and cable television service respectively, not providing Internet access. Moreover, in dealing with the owners of the network, it is quite possible that the end-users will pay higher rates to use those networks due to the lack of competition on the physical network.

### SUMMARY OF THE INVENTION

The inventors of the present invention have recognized that currently no methods, systems, or computer program products are available to allow end-users of an open access high-speed network for providing broadband data transport services to select a new service provider following a discontinuance of a business relationship between their current service provider and the operator of the open access high-speed network, without losing their access to the open access high-speed network. Accordingly, one object of the present invention is to provide a solution to this problem, as well as other problems and deficiencies associated with selecting a new service provider that provides service via an open access high-speed network for providing broadband data transport services. The broadband data transport services provided in the context of the present invention may include, but are not limited to any combination of analog video, digital video, data services, Internet access, packetized voice, voice-over-Internet Protocol, interactive video, interactive television, near video-on-demand, video-on-demand, data services, and telephony services.

The inventors of the present invention have recognized that one of the limitations of conventional approaches to providing Internet access is that sharing networks that are primarily used for other purposes impacts not only the performance of the network, but also introduces unnecessary contractual complexities for an end-user desiring, for example, Internet access. Accordingly, another object of the present invention is to provide an open access high-speed network for providing broadband data transport services through which many service providers (e.g., Internet service providers) may compete for the business of end-users desiring high-speed access to a network (e.g., for accessing the Internet).

The inventors of the present invention have further recognized that services provided by ISPs are essentially fungible since there is a minimum set of services that many, if not all, end-users will demand from their service providers. The inventors have further recognized that since these fungible services are provided regardless of the method of connectivity to the network, it is the nature of the connection to the network that has become a primary consideration for end-users. The inventors of the present invention have further recognized that, as an example, those end-users desiring a higher speed connection to the Internet will decide first, whether they desire connectivity through a DSL link, or through a cable modem link, then, will identify which ISPs have relationships with those network owners (or the network owners themselves) that allow them to offer connectivity through those higher speed networks. Accordingly, the inventors of the present invention have recognized that it would be advantageous for the end-users of an open access high-speed network to select a new service provider providing services via the open access high-speed network following a discontinuance of the business relationship between their current service provider and the operator of the open access high-speed network. As discussed above, the inventors of the present invention have recognized that it is the nature of the connection provided (i.e., via a high-speed network) that is a priority of the end-user, such that when a service provider becomes unavailable, the end-users will desire to switch service providers to maintain their access to the open access high-speed network.

The above-described and other objects are addressed by the present invention which includes a novel computer-based system, method, and computer program product through which an end-user having access to an open access high-speed network for providing broadband data transport services may select a new service provider without losing access to the open access high-speed network following a discontinuance of a business relationship between their current service and the operator of the open access high-speed network. End-users are able to maintain the quality of their network connectivity by maintaining their connection to the open access high-speed network while maintaining a service relationship with any one of the service providers that have a current relationship with the operator of the open access high-speed network.

In one embodiment, the present invention is implemented as a system for an end-user to select a new service provider while maintaining connectivity to the open access high-speed network. The system includes a digital repository populated with information regarding the end-users and their corresponding service providers. If a relationship between a service provider and the operator of the open access high-speed network is severed, the end-user impacted by this change in status is provided an opportunity to select a new service provider that has a current business relationship with the operator of the open access high-speed network.

Consistent with the title of this section, the above summary is not intended to be an exhaustive discussion of all the features or embodiments of the present invention. A more complete, although not necessarily exhaustive, description of the features and embodiments of the invention is found in the section entitled “DESCRIPTION OF THE PREFERRED EMBODIMENTS.”

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of an open access high-speed network for providing broadband data transport services through which end-users connect to a communications network via a hybrid fiber optic/coaxial network through one of several service providers having a relationship with the operator of the open access high-speed network;

FIG. 2 is a block diagram of a system configuration of an operations support system of an open access high-speed network providing end-users access to a network through one of multiple service providers according to one embodiment of the present invention;

FIG. 3 is a flow diagram showing a high-level process for redirecting an end-user to an application for selecting a new service provider when it has been determined that a business relationship between the end-user's current service provider and the party responsible for the open access high-speed network has been terminated according to one embodiment of the present invention;

FIGS. 4A and 4B are a flow diagram showing a process implementing the process described in FIG. 3 in an IP environment according to one embodiment of the present invention;

FIG. 5 is a flow diagram showing a process through which the redirecting of an end-user to a service provider selection capability expires after a predetermined amount of time according to one embodiment of the present invention;

FIG. 6 is a flow diagram showing a process through which a list of available service providers is presented to an end-user that has not explicitly declined selection of a new service provider according to one embodiment of the present invention;

FIGS. 7A-7C show an exemplary database structure for a database of an operations support system of an open access high-speed network supporting multiple service providers where the relationship between one of those service providers and the operator of the open access high-speed network has been discontinued, and those end-users using that service provider have been offered an opportunity to switch service providers according to one embodiment of the present invention; and

FIG. 8 is an exemplary computer system programmed to perform one or more of the special purpose functions of the present invention.

### DESCRIPTION OF THE PREFERRED EMBODIMENTS

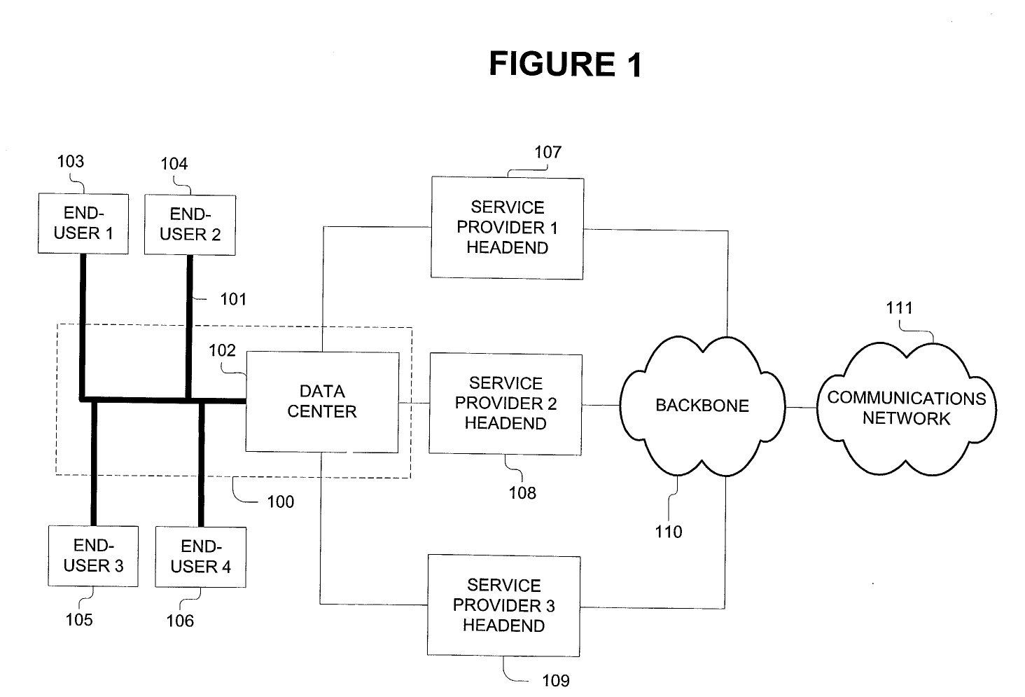

Referring now to the drawings, wherein like reference numerals designate identical or corresponding parts throughout the several views, and more particularly to FIG. 1 thereof, which is a block diagram of an open access high-speed network for providing broadband data transport services including access to a communications network (e.g., the Internet) according to one embodiment of the present invention. The system includes a high-speed network 100 for providing broadband data transport services. In one embodiment of the present invention, the open access high-speed network 100 provides end-users 103-106 with connectivity to a communications network 111 (e.g., the Internet) via a backbone 110 using services provided by one of several service providers 107-109 providing services via the open access high-speed network 100 and having access to a backbone 110. Connectivity between the end-users 103-106 and the data center 102 of the open access high-speed network 100 is through a high-speed access network 101 such as, for example, a hybrid fiber optic/coaxial network, a Digital Subscriber Line (DSL) based network, a wireless broadband network, or other high-speed network. In other embodiments of the present invention, the open access high-speed network 100 is used to provide other data transport services, including, but not limited to, data services, packetized voice, voice-over-Internet protocol (IP) services, other telephony services, analog and/or digital video services, near video-on-demand, video-on-demand, interactive video, or interactive television. In some embodiments of the present invention, the high-speed network is dedicated to providing only one or more particular services. In these embodiments, network performance can be increased by allocating the entire bandwidth of the high-speed network 100 to the particular service(s), in contrast to many conventional networks where a portion of the bandwidth is preallocated (e.g., to analog cable television signals), thereby limiting the amount of useable bandwith.

The details of the network configuration shown in FIG. 1 including the connectivity between the end-users 103-106 and the open access high-speed network 100, and the connectivity between the open access high-speed network 100 and the multiple service providers 107-109, are disclosed in application Ser. No. 09/784,074 entitled “SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM.”

In various embodiments of the present invention, the high-speed network 100 is a Data Over Cable Service Interface Specification (DOCSIS) network, a European Data Over Cable Service Interface Specification network, or a Point-to-Point Protocol over Ethernet (PPPOE) network.

As shown in FIG. 1, end-users 103-106 having connectivity to the communications network 111 via the open access high-speed network 100 may have a subscription to any one of the service providers 107-109. Moreover, should one of the service providers 107-109 have their relationship with the operator of the open access high-speed network 100 severed, the operator of the open access high-speed network can provide those end-users 103-106 having service contracts with the terminated service provider 107-109 with an opportunity to enter into a service contract with one of those other service providers 107-109 still having a contractual relationship with the operator of the open access high-speed network 100. Accordingly, the services provided by the service providers 107-109 can be viewed by the end-users 103-106 as fungible services that do not impact the quality of their connection to the communications network 111.

The system of the present invention provides a competitive environment, through which the service providers 107-109 may compete for the business of the end-users 103-106. Accordingly, the end-users 103-106 may select a new service provider for reasons including, but not limited to, services offered, quality of customer service, or price.

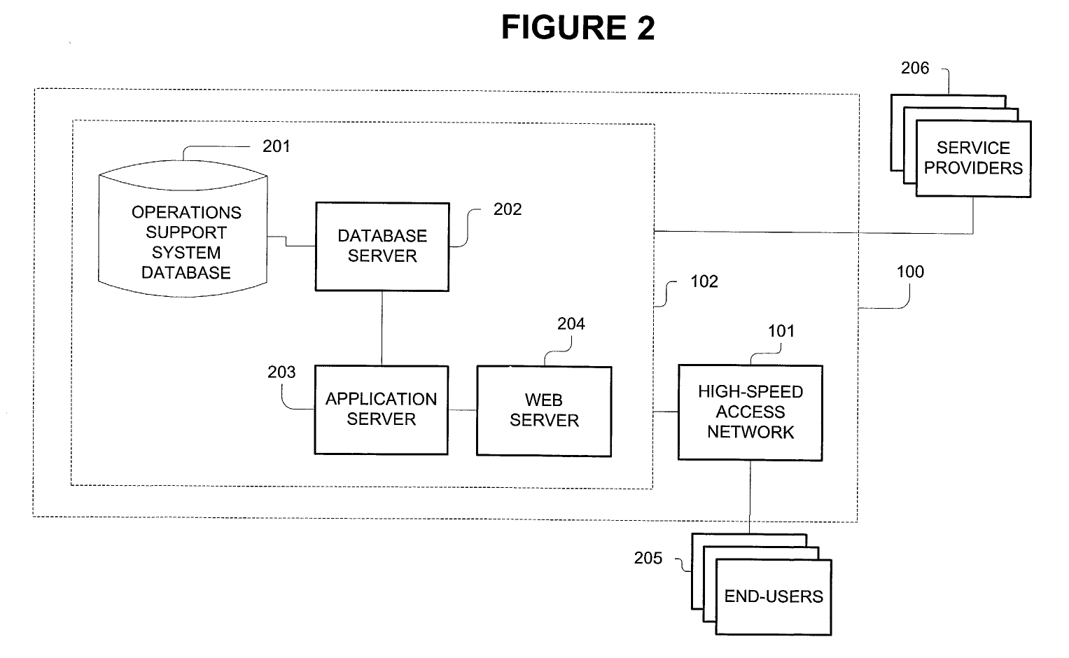

FIG. 2 is a block diagram of a system configuration of an operations support system 102 of an open access high-speed network 100 for providing broadband data transport services. As shown in FIG. 2, end-users 205 are connected to the open access high-speed network 100 through a high-speed access network 101, for example, a hybrid fiber optic/coaxial (HFC) network, a DSL based network, a wireless broadband network, or other high-speed network. The operations support system includes an operations support system database 201, a database server 202, an application server 203, and a Web server 204.

The operations support system database 201 is a digital repository that may be implemented, for example, through a commercially available relational database management system (DBMS) based on the structured query language (SQL) such as ORACLE, DB2, SYBASE, INFORMIX, or MICROSOFT SQL SERVER, through an object-oriented database management system (ODBMS), or through custom database management software. In one embodiment of the present invention, the operations support system database 201 includes information concerning the subscription relationships between the end-users 205 and the service providers 206.

In one embodiment of the present invention, the operations support system database 201, includes information such as provisioning information, billing information, general ledger information, and accounts payable information that supports the relationship between the operator of the high-speed network 100 and the service providers 206 having customers (i.e., the end-users 205) connected to the high-speed network 100.

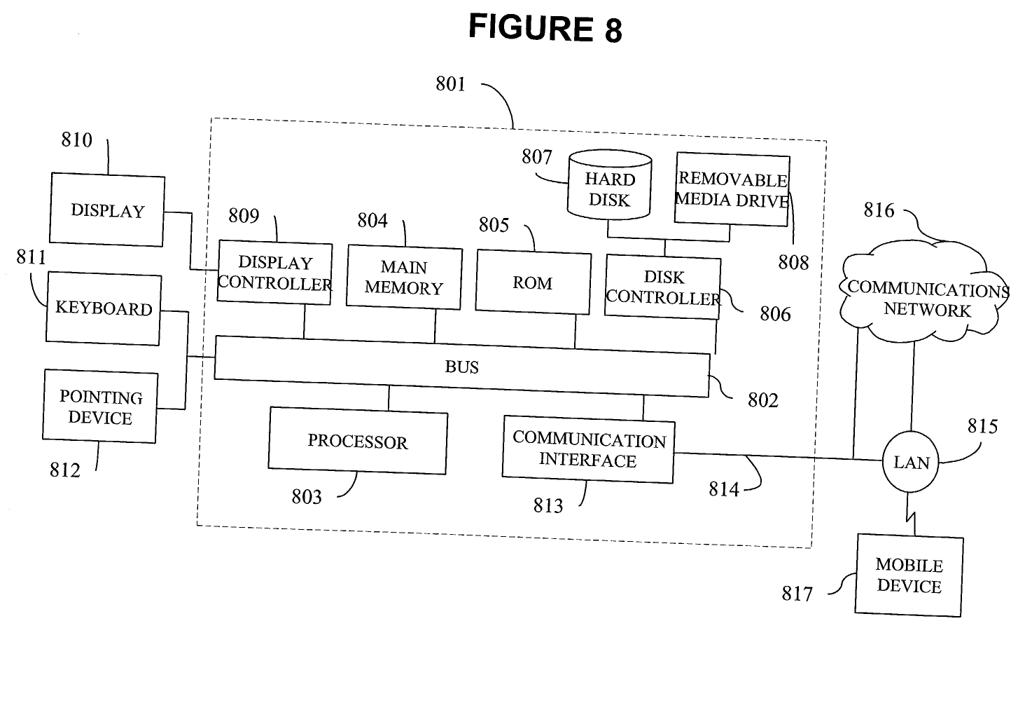

Processes running on the database server 202 maintain the information in the operations support system database 201. The database server 202 is implemented using the computer system 801 of FIG. 8, for example, but also may be any other suitable personal computer (PC), workstation, server, or device for maintaining the information in the operations support system database 201. The operations support system database 201 may reside on a storage device of the database server 202, or reside on another device connected to the database server 202, for example, by way of a local area network, or other communications link such as a virtual private network, wireless link, or Internet-enabled link.

The application server 203 may be implemented using the computer system 801 of FIG. 8, for example, or any other suitable PC, workstation, server, or other device for hosting applications that are used to maintain the various types of information stored in the operations support system database 201. Applications running on the application server 203 interact with the information held in the operations support system database 201 through the database server 202.

The web server 204 may be implemented using the computer system 801 of FIG. 8, for example, or any other suitable PC, workstation, server, or other device for hosting an interface through which users may interact with applications running on the application server 203. In one embodiment of the present invention, the user interface provided by the web server 204 is accessible via the high-speed access network 101. In another embodiment, the user interface provided by the web server 204 is a world wide web interface accessible through the communications network 111 (e.g., the Internet). In those situations where a business relationship has been severed between one of the service providers 206 and the operator of the open access high-speed network 100, connectivity to the Internet will no longer be available for those end-users 205 subscribing to the discontinued service provider 206. In such a case, the end-users 205 are provided access to the user interface via the high-speed access network 101.

A business relationship between a service provider 206 and the operator of the open access high-speed network 100 could be discontinued for a variety of reasons. Those reasons include, but are not limited to, the operator of the open access high-speed network 100 terminating the relationship with a service provider 206 that is delinquent on their payments or violates their service agreement (e.g., by failing to enforce an acceptable use policy); the service provider 206 terminating the relationship with the operator of the open access network 100 based on a decision not to provide access to the open access network, the operator of the open access network failing to honor their service level agreements, or a decision by the service provider 206 to provide access to another open access provider; or the service provider becoming insolvent.

In one embodiment of the present invention, the interface is implemented as a browsable interface developed in a standard markup language (e.g., XML, HTML, DHTML, or HDML, etc.) accessible via commercially available web browser tools including, but not limited to, INTERNET EXPLORER, available from Microsoft Corporation and NETSCAPE NAVIGATOR, available from Netscape Communications Corporation or via proprietary browsers that support various markup languages such as XML, HTML, and DHTML, including, for example, those distributed by AOL. The commercially available web browser tool running on a workstation of a service provider 206 customer of the open access network 100, or on a workstation of an end-user 205 provides accessibility to the applications running on the application server 203 through the web interface provided by the web server 204.

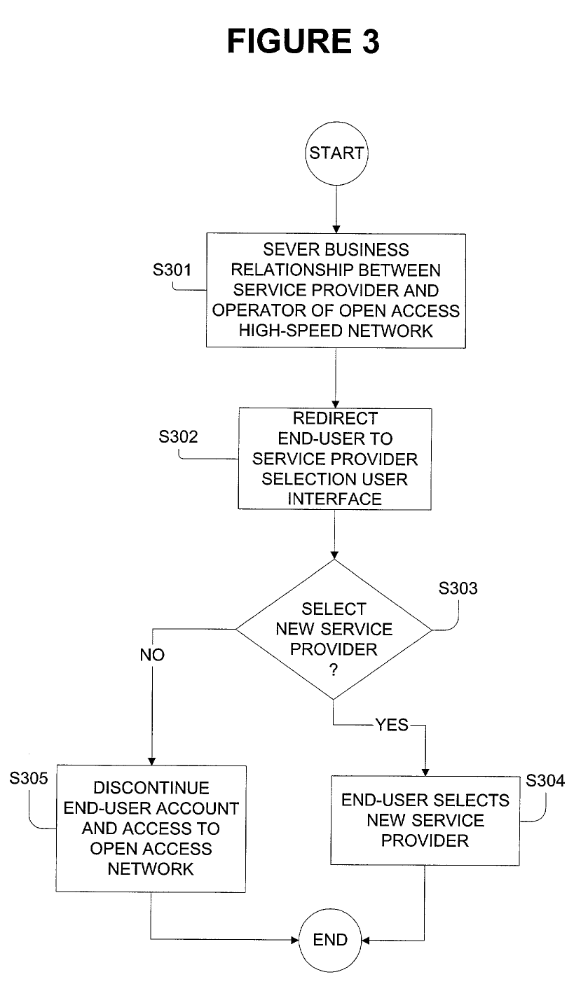

FIG. 3 is a flow diagram showing a high level summary of the process of the present invention through which an end-user 205 is redirected to a service provider selection user interface when a business relationship between a service provider 206 and the operator of the open access high-speed network 100 has terminated. As shown in FIG. 3, the process begins at step S301 where a business relationship between a service provider 206 and the operator of the open access high-speed network is severed. The process then proceeds to step S302 where end-users 205 of the discontinued service provider 206 are directed to a service provider selection user interface. The end-users 205 then select a new service provider 206 via the service provider selection user interface at step S303.

The redirection of an end-user 205 to a service provider selection user interface may be accomplished through various techniques. In one embodiment of the present invention, the operations support system 102 uses wild card domain name system (DNS) techniques to direct the end-user 205 by resolving all end-user 205 (DNS) address resolution requests to the IP address of the service provider selection user interface application. In other embodiments, policy-based or multi-protocol label switching (MPLS) based routing techniques are used to force all end-user 205 DNS and Web traffic to the service provider selection user interface application. In yet another embodiment, a tunneling technology such as the Layer Two Tunneling Protocol (L2TP) is used in conjunction with policy-based or MPLS-based routing techniques to force all end-user 205 DNS and Web traffic to the service provider selection user interface application.

Once an end-user 205 has been redirected to the service provider selection user interface at step S302, that application will be the only capability accessible by that end-user 205 until a new service provider 206 has been successfully selected. The process then proceeds to step S303 where the end-user 205 decides whether to select a new service provider 206. If the end-user 205 decides to select a new service provider 206 (i.e., “Yes” at step S303), the process proceeds to step S304 where a new service provider 206 is selected by the end-user 205. Once a new service provider 206 has been successfully selected by an end-user 205 at step S304, the process ends. If, on the other hand, the end-user 205 decides not to select a new service provider 206 (i.e., “No” at step S303), the process proceeds to step S305 where the end-user's 205 account with the operator of the open access high-speed network 100 is discontinued, and access to the open access high-speed network 100 will be denied. Once the end-user's 205 account has been discontinued at step S305, the process ends.

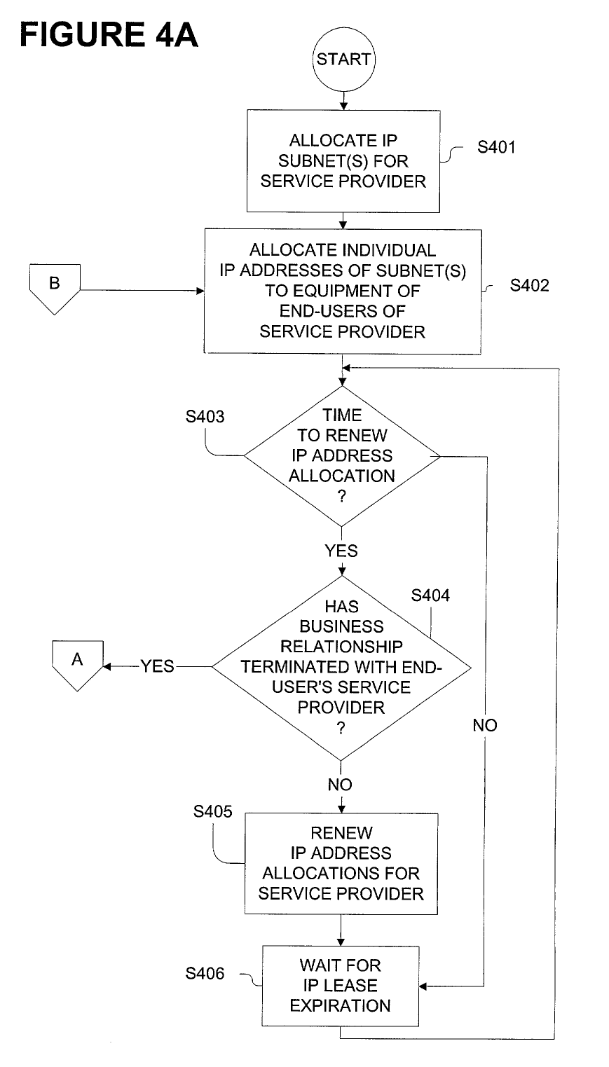

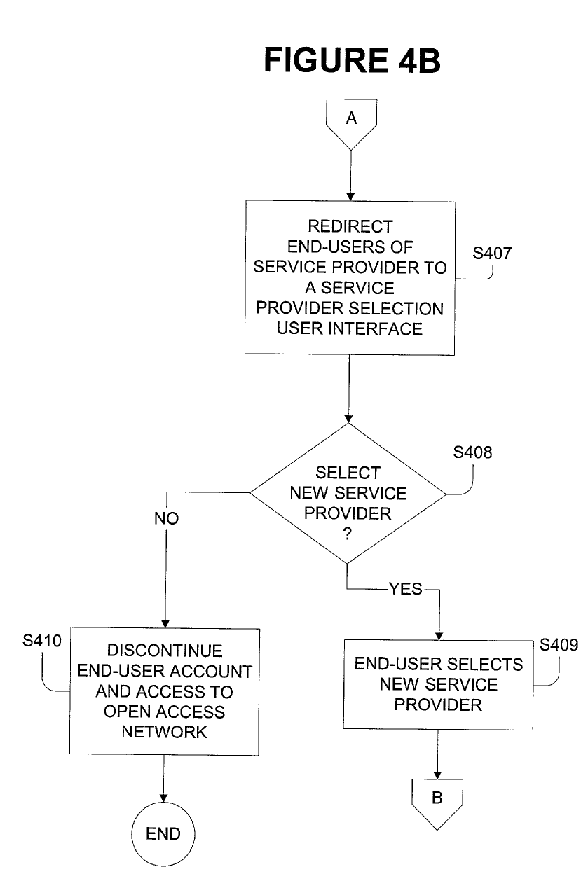

FIGS. 4A and 4B are a flow diagram providing a more detailed description of the process described in the context of FIG. 3. In particular, FIGS. 4A-4B illustrate an IP-based implementation of the present invention. As shown in FIG. 4A, the process begins at step S401 where one or more IP subnets for a particular service provider 206 are allocated. The process then proceeds to step S402 where the individual IP addresses of the subnet allocated in step S401 are allocated to the equipment of the end-users 205 subscribing to that service provider 206 corresponding to that subnet. The subnet enters into an “IP lease” which allocates particular IP addresses to the subnet for a fixed amount of time. The process then proceeds to step S403 where a process of the operations support system 102 determines if it is time to renew the IP address lease made in step S402. In one embodiment of the present invention, the renewal period for each IP lease is based on an internally configurable amount of time, after which the IP addresses are reallocated by the operations support system 102 in order to ensure that the current allocation reflects the most recent information maintained in the operations support system database 201. If it is not time to renew the IP address lease (i.e., “No” in step S403), the process proceeds to step S406 where it will wait until the IP address lease expires. After waiting until the IP lease expires at step S406, the process returns to step S403.

If, based on the internally configurable parameter, it is determined that it is time to renew the IP lease (i.e., “Yes” at step S403), the process proceeds to step S404 where a determination is made as to whether the business relationship between the service provider 206 corresponding to a particular subnet and the operator of the open access high-speed network 100 has terminated. If it is determined at step S404 that the business relationship between the operator of the open access high-speed network 100 and the particular service provider 206 has not terminated (i.e., “No” at step S404), the process proceeds to step S405 where the IP lease allocated to this particular service provider 206 is renewed. Once the IP lease is renewed, the process proceeds to step S406, where it will wait until it is again time to renew the IP lease. When the IP lease expires again, the process will return to step S403, described above.

If, on the other hand, it is determined at step S404 that the business relationship between the particular service provider 206 and the operator of the open access high-speed network 100 has terminated (i.e., “Yes” at step S404), the process proceeds to step S407, shown in FIG. 4B where each end-user 205 subscribing to that particular service provider 206 is redirected to a service provider selection user interface application. As discussed above, once it is determined that an end-user 205 has a subscription with a service provider 206 that no longer has a business relationship with the operator of the open access high-speed network 100, the only capability that that end-user 205 will be able to access will be the service provider selection user interface application until that end-user 205 successfully selects a new service provider 206. Once an end-user 205 has been redirected to the service provider selection user interface at step S407, that application will be the only capability accessible by that end-user 205 until a new service provider 206 has been successfully selected. The process then proceeds to step S408 where the end-user 205 decides whether to select a new service provider 206. If the end-user 205 decides to select a new service provider 206 (i.e., “Yes” at step S408), the process proceeds to step S409 where a new service provider 206 is selected by the end-user 205. Once a new service provider 206 has been successfully selected by an end-user 205 at step S409, the process returns to step S402, described above and shown on FIG. 4A, where individual IP addresses are allocated to the equipment of the end-user 205.

If, on the other hand, the end-user 205 decides not to select a new service provider 206 (i.e., “No” at step S408), the process proceeds to step S410 where the end-user's 205 account with the operator of the open access high-speed network 100 is discontinued, and access to the open access high-speed network 100 will be denied. Once the end-user's 205 account has been discontinued at step S410, the process ends.

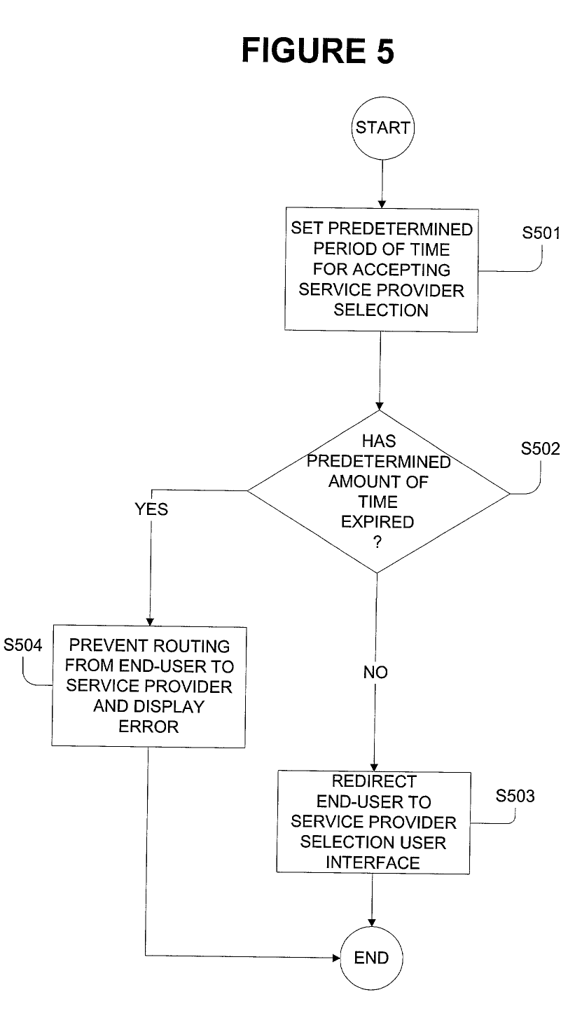

FIG. 5 is a flow diagram showing a process through which an end-user 205 is provided a predetermined amount of time in which to select a new service provider 206 once it has been determined that the relationship between the service provider 206 and the operator of the open access high-speed network 100 has been terminated according to one embodiment of the present invention. As shown in FIG. 5, the process begins at step S501 where a process of the operations support system 102 will set a predetermined period of time for accepting a selection of a new service provider 206 by the end-user 205. In one embodiment of the present invention, the predetermined period of time is set to a seven day period following a discontinuance of a relationship between the service provider and the operator of the open access high-speed network 100. The process then proceeds to step S502 where it is determined whether the predetermined amount of time has expired. If it is determined in step S502 that the predetermined amount of time has not expired (i.e., “No” at step S502), the process proceeds to step S503 where the end-user 205 is redirected to the service provider selection user interface application, using techniques including those discussed above. Once the end-user 205 has been redirected to the service provider selection user interface application, the process ends.

If, on the other hand, it is determined that the predetermined amount of time has expired (i.e., “Yes” at step S502), the process proceeds to step S504 where the end-user 205 is prevented from being routed to the service provider selection user interface application. Instead, a message is displayed for the end-user 205 indicating, for example, that the end-user 205 does not currently have a relationship with a service provider 206 that is currently a customer of the open access high-speed network 100. Once this point has been reached, the process ends.

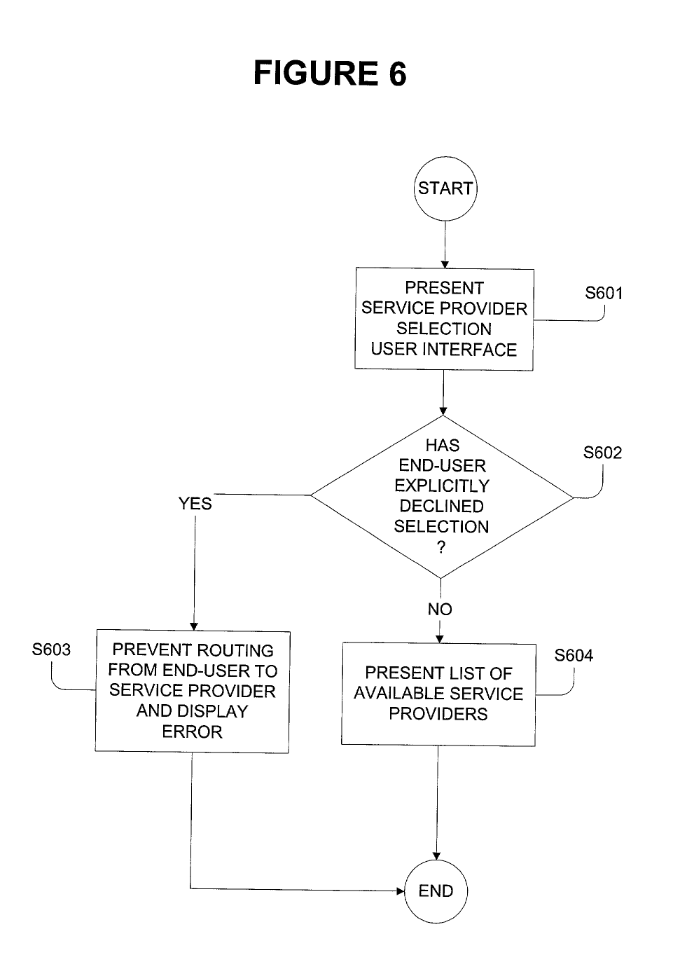

FIG. 6 is a flow diagram showing a process through which an end-user 205 may explicitly decline to select a new service provider 206 according to one embodiment of the present invention. As shown in FIG. 6, the process begins at step S601 where the end-user 205 is presented the service provider selection user interface. The process then proceeds to step S602 where it is determined whether the end-user 205 has explicitly declined to select a new service provider 206. In one embodiment of the present invention, the end-user may make this explicit indication via the service provider selection user interface. If the end-user 205 has not explicitly declined the selection of a new service provider 206 (i.e., “No” at step S602), the process proceeds to step S604 where the end-user 205 is presented a list of available service providers 206 from which a selection may be made. The selection of a new service provider 206 is explained in detail in provisional application Serial No. 60/268,896 entitled “SYSTEM, METHOD, AND COMPUTER PROGRAM PRODUCT FOR ENDUSER SERVICE PROVIDER SELECTION.”

If, on the other hand, it is determined that the end-user 205 has explicitly declined to select a new service provider 206 (i.e., “Yes” at step S602), the process proceeds to step S603 where the end-user 205 is prevented from being routed to the service provider selection user interface application, and an appropriate message is displayed to the end-user 205 when they attempt to access the open access high-speed network 100.

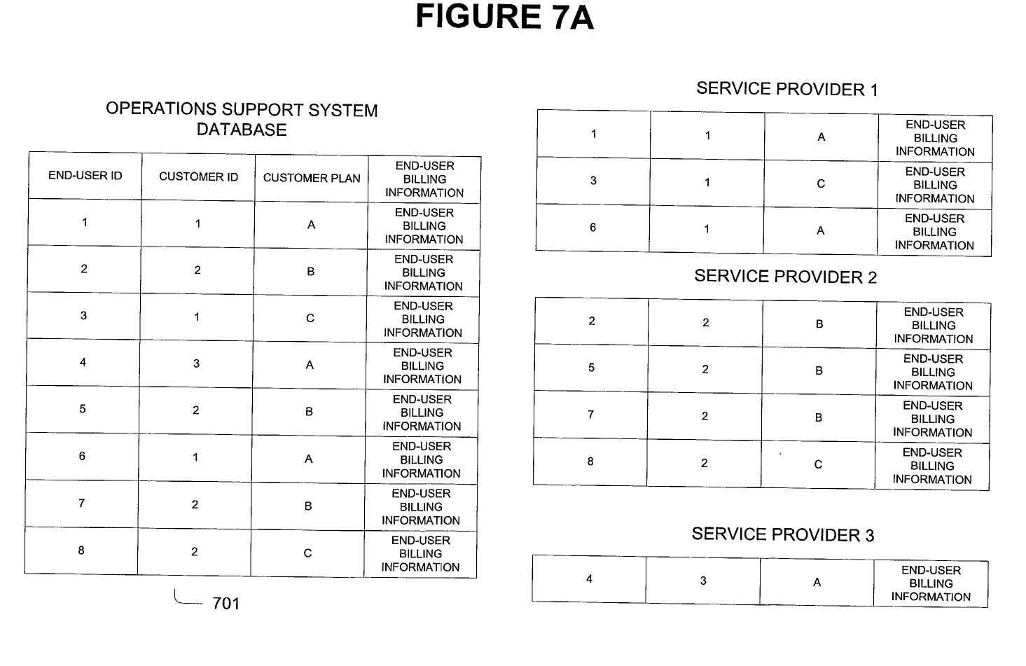

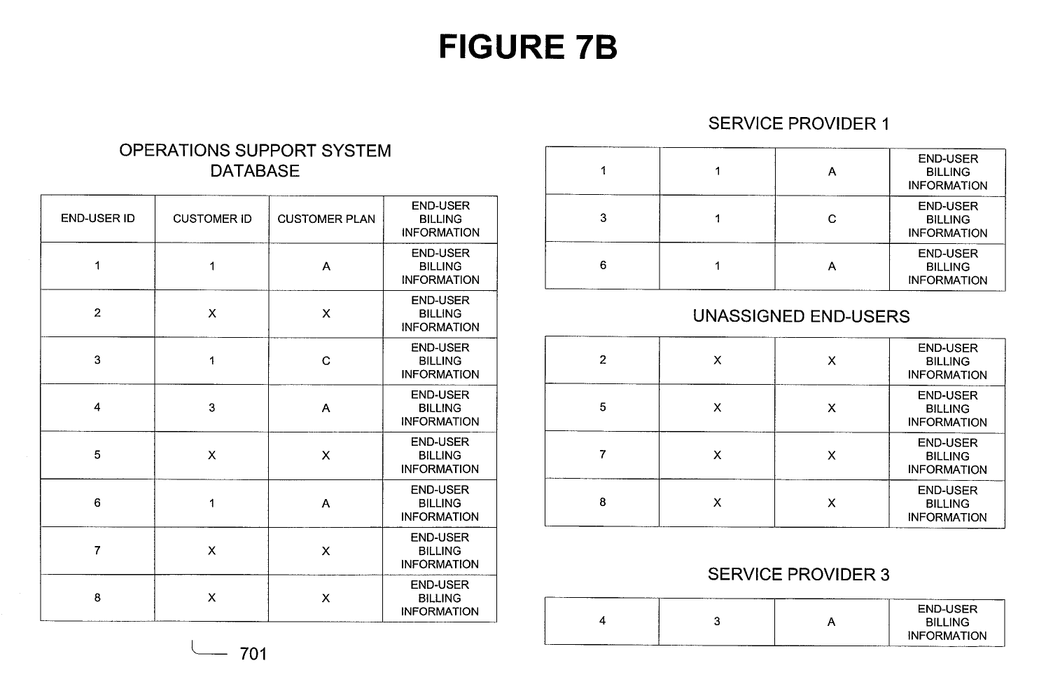

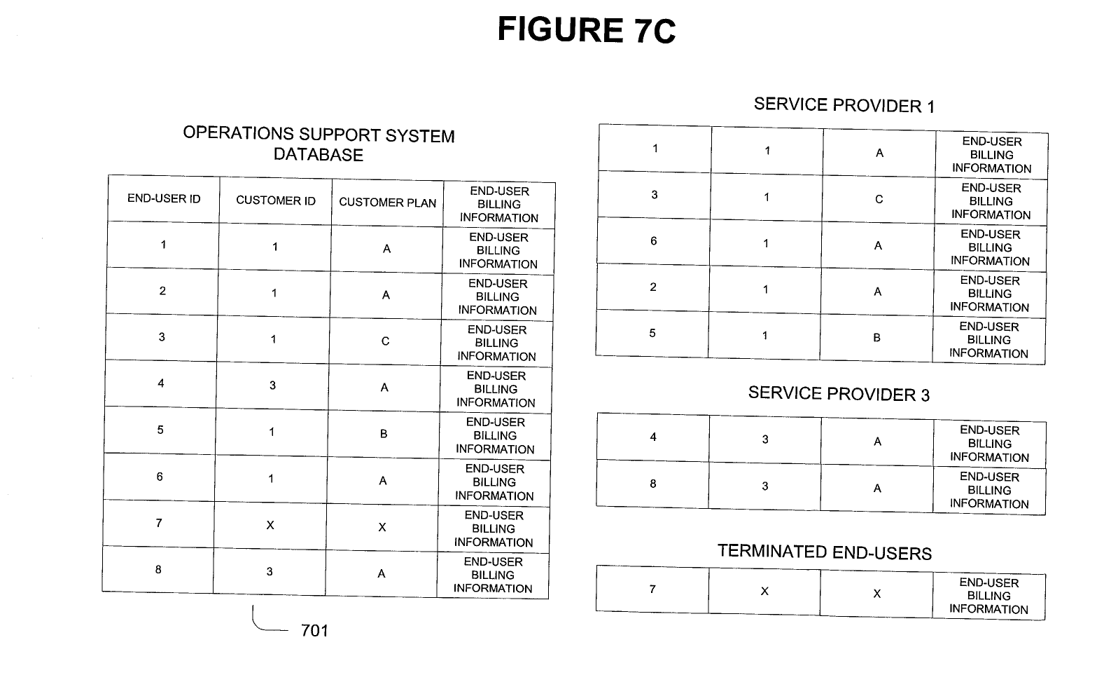

FIGS. 7A-7C show an exemplary database structure for an operations support system database 201 supporting multiple service providers 206 according to one embodiment of the present invention. FIGS. 7A-7C illustrate an exemplary manipulation of the information maintained in the operations support system database 201 in the context of the present invention. As shown in FIG. 7A, a single query of the operations support system database 201 produces a result 701 that may include several end-users 205 (i.e., individual connections to the open access high-speed network 100), each end-user 205 being a customer of a particular service provider 206, each of those service providers 206 being a customer of the operator of the open access high-speed network 100. Each customer of the open access high-speed network 100 (e.g., an ISP) may offer a variety of service plans to their customers (i.e., end-users 205). For example, a particular service provider 206 may offer three different rate plans (e.g., customer plan A, customer plan B, customer plan C).

On the right hand side of FIG. 7A, is the same information contained in the query results 701, but grouped by service provider 206. By including a customer ID (i.e., customer of the operator of the open access high-speed network 100, for example, a service provider) field in the operations support system database 201, it is possible to easily group those end-users 205 that have a service contract with a particular service provider 206.

FIG. 7B illustrates an exemplary approach for indicating which end-users 205 are affected by the termination of a contract between a particular service provider 206 and the operator of the open access high-speed network 100 according to one embodiment of the present invention. As shown in FIG. 7B, in this example, the service provider 206 having a customer ID of 2 has had their business relationship with the operator of the open access high-speed network 100 discontinued. FIG. 7B shows that the customer ID field and the customer plan field have been marked with an ‘X’ for each of those records corresponding to end-users 205 that were subscribers of the impacted service provider 206, in this example, the service provider having a customer ID of 2. On the right-hand of FIG. 7B is the same information shown in the left-hand side, but grouped according to each end-user's 205 current service provider 206. As shown on the right-hand side of FIG. 7B, the records corresponding to those end-users 205 subscribing to service providers having customer IDs of 1 and 3 are not impacted by the discontinuance of the relationship between service provider 2 and the operator of the open access high-speed network 100. However, those end-users 205 that were subscribing to service provider 2 are now unassigned, as shown by the middle group on the right-hand side of FIG. 7B. These unassigned end-users 205 correspond to those end-users 205 that will be redirected by processes of the operation support system 102 to the service provider selection user interface application upon attempting to connect to the open access high-speed network 100 subsequent to the discontinuance of the relationship between the operator of the open access high-speed network 100 and service provider 2.

FIG. 7C illustrates an exemplary result of the unassigned end-users 205 shown in FIG. 7B selecting new service providers 206 subsequent to the discontinuance of the relationship between the operator of the open access high-speed network 100 and service provider 2 according to one embodiment of the present invention. As shown in FIG. 7C, unassigned end-users 205 having end-user IDs of 2, 5, and 8 have selected new service providers 206 through which they will continue their service on the open access high-speed network 100. In the example shown in FIG. 7C, end-users 205 having end-user IDs 2 and 5 have selected service provider 1 as their new service provider 206. The end-user 205 having end-user ID 8 has selected service provider 3 as their new service provider. End-user 205 having end-user ID 7 has opted to not select a new service provider and, therefore, will no longer have access to the open access high-speed network 100. As further shown in FIG. 7C, as end-users 205 select new service providers 206, they may select a customer plan of their new service provider 206 that best suits their needs.

FIG. 8 illustrates a computer system 801 upon which an embodiment of the present invention may be implemented. The present invention may be implemented on a single such computer system, or a collection of multiple such computer systems. The computer system 801 includes a bus 802 or other communication mechanism for communicating information, and a processor 803 coupled with the bus 802 for processing the information. The computer system 801 also includes a main memory 804, such as a random access memory (RAM) or other dynamic storage device (e.g., dynamic RAM (DRAM), static RAM (SRAM), and synchronous DRAM (SDRAM)), coupled to the bus 802 for storing information and instructions to be executed by processor 803. In addition, the main memory 804 may be used for storing temporary variables or other intermediate information during the execution of instructions by the processor 803. The computer system 801 further includes a read only memory (ROM) 805 or other static storage device (e.g., programmable ROM (PROM), erasable PROM (EPROM), and electrically erasable PROM (EEPROM)) coupled to the bus 802 for storing static information and instructions for the processor 803.

The computer system 801 also includes a disk controller 806 coupled to the bus 802 to control one or more storage devices for storing information and instructions, such as a magnetic hard disk 807, and a removable media drive 808 (e.g., floppy disk drive, read-only compact disc drive, read/write compact disc drive, compact disc jukebox, tape drive, and removable magneto-optical drive). The storage devices may be added to the computer system 801 using an appropriate device interface (e.g., small computer system interface (SCSI), integrated device electronics (IDE), enhanced-IDE (E-IDE), direct memory access (DMA), or ultra-DMA).

The computer system 801 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 801 may also include a display controller 809 coupled to the bus 802 to control a display 810, such as a cathode ray tube (CRT), for displaying information to a computer user. The computer system includes input devices, such as a keyboard 811 and a pointing device 812, for interacting with a computer user and providing information to the processor 803. The pointing device 812, for example, may be a mouse, a trackball, or a pointing stick for communicating direction information and command selections to the processor 803 and for controlling cursor movement on the display 810. In addition, a printer may provide printed listings of the data structures/information, or any other data stored and/or generated by the computer system 801.

The computer system 801 performs a portion or all of the processing steps of the invention in response to the processor 803 executing one or more sequences of one or more instructions contained in a memory, such as the main memory 804. Such instructions may be read into the main memory 804 from another computer readable medium, such as a hard disk 807 or a removable media drive 808. One or more processors in a multi-processing arrangement may also be employed to execute the sequences of instructions contained in main memory 804. In alternative embodiments, hard-wired circuitry may be used in place of or in combination with software instructions. Thus, embodiments are not limited to any specific combination of hardware circuitry and software.

As stated above, the computer system 801 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 801, for driving a device or devices for implementing the invention, and for enabling the computer system 801 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 803 for execution. A computer readable medium may take many forms, including but not limited to, non-volatile media, volatile media, and transmission media. Non-volatile media includes, for example, optical, magnetic disks, and magneto-optical disks, such as the hard disk 807 or the removable media drive 808. Volatile media includes dynamic memory, such as the main memory 804. Transmission media includes coaxial cables, copper wire and fiber optics, including the wires that make up the bus 802. Transmission media also may also take the form of acoustic or light waves, such as those generated during radio wave and infrared data communications.

Various forms of computer readable media may be involved in carrying out one or more sequences of one or more instructions to processor 803 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 801 may receive the data on the telephone line and use an infrared transmitter to convert the data to an infrared signal. An infrared detector coupled to the bus 802 can receive the data carried in the infrared signal and place the data on the bus 802. The bus 802 carries the data to the main memory 804, from which the processor 803 retrieves and executes the instructions. The instructions received by the main memory 804 may optionally be stored on storage device 807 or 808 either before or after execution by processor 803.

The computer system 801 also includes a communication interface 813 coupled to the bus 802. The communication interface 813 provides a two-way data communication coupling to a network link 814 that is connected to, for example, a local area network (LAN) 815, or to another communications network 816 such as the Internet. For example, the communication interface 813 may be a network interface card to attach to any packet switched LAN. As another example, the communication interface 813 may be a Digital Subscriber Line (DSL) card, an integrated services digital network (ISDN) card or a modem to provide a data communication connection to a corresponding type of communications line. Wireless links may also be implemented. In any such implementation, the communication interface 813 sends and receives electrical, electromagnetic or optical signals that carry digital data streams representing various types of information.

The network link 814 typically provides data communication through one or more networks to other data devices. For example, the network link 814 may provide a connection to another computer through a local network 815 (e.g., a LAN) or through equipment operated by a service provider, which provides communication services through a communications network 816. In preferred embodiments, the local network 814 and the communications network 816 preferably use electrical, electromagnetic, or optical signals that carry digital data streams. The signals through the various networks and the signals on the network link 814 and through the communication interface 813, which carry the digital data to and from the computer system 801, are exemplary forms of carrier waves transporting the information. The computer system 801 can transmit and receive data, including program code, through the network(s) 815 and 816, the network link 814 and the communication interface 813. Moreover, the network link 814 may provide a connection through a LAN 815 to a mobile device 817 such as a personal digital assistant (PDA), laptop computer, or cellular telephone. The LAN communications network 815 and the communications network 816 both use electrical, electromagnetic or optical signals that carry digital data streams. The signals through the various networks and the signals on the network link 814 and through the communication interface 813, which carry the digital data to and from the system 801, are exemplary forms of carrier waves transporting the information. The computer system 801 can transmit notifications and receive data, including program code, through the network(s), the network link 814 and the communication interface 813.

Obviously, numerous modifications and variations of the present invention are possible in light of the above teachings. It is therefore to be understood that within the scope of the appended claims, the invention may be practiced otherwise than as specifically described herein.

What is claimed is:

1. A system for one of a plurality of end-users of a common network to select a second service provider as a replacement for a first service provider, the first service provider and the second service provider providing services on the common network as customers of an operator of a high-speed network configured to provide connectivity between the plurality end-users and both of the first service provider and the second service provider, comprising:
a digital repository populated with a plurality of end-user entries, each end-user entry corresponding to a unique one of the plurality of end-users and including a current service provider indicator for the corresponding end-user;
a processor; and
a computer readable medium encoded with processor readable instructions that when executed by the processor implement
a service provider discontinuation mechanism configured to store in a memory an indicator that the first service provider is no longer a customer of the operator of the high-speed network,
an end-user determination mechanism configured to access the indicator in the memory and to query the digital repository to identify which of the plurality of end-users of the common network have a current service provider indicator indicating the first service provider, and
a service provider selection mechanism configured to access the digital repository via the high-speed network by the one of the plurality of end-users, select the second service provider as a new service provider, and to update the current service provider indicator for the one of the plurality of end-users in the digital repository to reflect the second service provider, and
an end-user redirection mechanism configured to direct each of the plurality of end-users identified by the end-user determination mechanism accessing the high-speed network to the service provider selection mechanism.

2. The system of claim 1, wherein the digital repository comprises a database.

3. The system of claim 1, wherein the high-speed network comprises a network configured to provide at least one of Internet access, digital video services, analog video services, packetized voice, voice-over-Internet Protocol, interactive video, interactive television, near video-on-demand, video-on-demand, data services, and telephony services.

4. The system of claim 1, wherein the high-speed network comprises an open access network.

5. The system of claim 1, wherein at least a portion of the common network comprises an Internet protocol network.

6. The network of claim 1, wherein at least a portion of the common network comprises the Internet.

7. The system of claim 1, wherein at least a portion of the high-speed network comprises at least one of a hybrid fiber optic coaxial network, a Digital Subscriber Line network, and a wireless broadband network.

8. The system of claim 1, wherein at least one of the first service provider and the second service provider comprise an Internet service provider.

9. The system of claim 1, wherein the end-user redirection mechanism is further configured to direct each of the plurality of end-users to the service provider selection mechanism using a wildcard Domain Name System technique to resolve an end-user Domain Name System address resolution request to an IP address of the service provider selection mechanism.

10. The system of claim 1, wherein the end-user redirection mechanism is further configured to use at least one of policy-based routing and multi-protocol label switching-based routing to direct each of the plurality of end-users to the service provider selection mechanism.

11. The system of claim 1, wherein the end-user redirection mechanism is further configured to use at least one of a tunneling technique, a policy-based routing technique, and a multi-protocol label switching based routing technique to direct each of the plurality of end-users to the service provider selection mechanism.

12. The system of claim 11, wherein the tunneling technique comprises a Layer Two Tunneling Protocol.

13. The system of claim 1, wherein:
the computer readable medium is further encoded with processor readable instructions that when executed by the processor further implements
an IP subnet management mechanism configured to
allocate a first subnet corresponding to the first service provider and a second subnet corresponding to the second service provider,
allocate a first IP address of the first subnet to a first device of a first end-user of the first service provider and a second IP address of the second subnet to a second device of a second end-user of the second service provider, and
renew IP addresses of the first subnet and the second subnet at a predetermined period, wherein
the IP subnet management mechanism does not renew IP addresses of the first subnet subsequent to the service provider discontinuation mechanism storing the indicator in the memory.

14. The system of claim 1, wherein the end-user redirection mechanism is further configured to direct each of the plurality of end-users for a predetermined duration following an indication by the service provider discontinuation mechanism that the first service provider is no longer available to provide services on the high-speed network.

15. The system of claim 14, wherein the predetermined duration comprises a configurable amount of time.

16. The system of claim 14, wherein the end-user redirection mechanism is further configured to display a message to an end-user that has not selected a new service provider during the predetermined duration.

17. A method for one of a plurality of end-users to select a second service provider as a replacement for a first service provider, the first service provider and the second service provider providing services on the common network as customers of an operator of a high-speed network configured to provide connectivity between the plurality of end-users and both the first service provider and the second service provider, comprising the steps of:
storing an indicator in a memory indicating that the first service provider is no longer a customer of the operator of the high-speed network;
querying a digital repository to identify the one of the plurality of end-users subscribing to the first service provider for services on the common network;
redirecting the one of the plurality of end-users to a service provider selection application when accessing the high-speed network; and
selecting the second service provider as a replacement for the first service provider by the one of the plurality of end-users.

18. The method of claim 17, wherein the step of redirecting comprises redirecting the one of a plurality of end-users to the service provider selection application for a predetermined amount of time.

19. The method of claim 18, further comprising the step of:
displaying a message to the one of the plurality of end-users when accessing the common network after the predetermined amount of time.

20. The method of claim 18, wherein the predetermined amount of time comprises a configurable amount of time.

21. The method of claim 17, further comprising the steps of:
allocating a first subnet for the first service provider and a second subnet for the second service provider;
allocating individual IP addresses to equipment of each of the plurality of end-users such that end-users subscribing to the first service provider are allocated IP addresses corresponding to the first subnet and end-users subscribing to the second service provider are allocated IP addresses corresponding to the second subnet; and
renewing at a predetermined period IP addresses corresponding to the first subnet and the second subnet, wherein
IP addresses are not renewed for the subnet corresponding to the first service provider subsequent to the first service provider being indicated as no longer being a customer of the operator of the high-speed network.

22. A system for one of a plurality of end-users to select a second service provider as a replacement for a first service provider, the first service provider and the second service provider providing services on the common network as customers of an operator of a high-speed network providing connectivity between the plurality of end-users and both of the first service provider and the second service provider, comprising:
means for storing an indicator in a memory indicating that the first service provider is no longer a customer of the operator of the high-speed network;
means for querying a digital repository to identify the one of the plurality of end-users subscribing to the first service provider for services on the common network;
means for redirecting the one of the plurality of end-users to a service provider selection application when accessing the high-speed network; and
means for selecting the second service provider as a replacement for the first service provider by the one of the plurality of end-users.

23. The system of claim 22, further comprising:
means for allocating a first subnet for the first service provider and a second subnet for the second service provider;
means for allocating individual IP addresses to equipment of each of the plurality of end-users such that end-users subscribing to the first service provider are allocated IP addresses corresponding to the first subnet and end-users subscribing to the second service provider are allocated IP addresses corresponding to the second subnet; and
means for renewing at a predetermined period IP addresses corresponding to the first subnet and the second subnet, wherein
the means for renewing does not renew IP addresses for the subnet corresponding to the first service provider subsequent to the first service provider being indicated as no longer being a customer of the operator of the high-speed network.

24. The system of claim 22, wherein the digital repository comprises a database.

25. The system of claim 22, wherein the high-speed network comprises a network configured to provide at least one of Internet access, digital video services, analog video services, packetized voice, voice-over-Internet Protocol, interactive video, interactive television, near video-on-demand, video-on-demand, data services, and telephony services.

26. The system of claim 22, wherein the high-speed network comprises an open access network.

27. The system of claim 22, wherein at least a portion of the common network comprises an Internet protocol network.

28. The network of claim 22, wherein at least a portion of the common network comprises the Internet.

29. The system of claim 22, wherein at least a portion of the high-speed network comprises at least one of a hybrid fiber optic coaxial network, a Digital Subscriber Line network and a wireless broadband network.

30. The system of claim 22, wherein at least one of the first service provider and the second service provider comprise an Internet service provider.

31. The system of claim 22, wherein the means for redirecting is configured to direct each of the plurality of end-users to the means for selecting using a wildcard Domain Name System technique to resolve an end-user Domain Name System address resolution request to an IP address of the means for selecting.

32. The system of claim 1, wherein the means for redirecting is configured to use at least one of a policy-based routing and a multi-protocol label switching based routing to direct each of the plurality of end-users to the means for selecting.

33. The system of claim 1, wherein the means for redirecting is configured to use at least one of a tunneling technique a policy-based routing technique and a multi-protocol label switching based routing technique to direct each of the plurality of end-users to the means for selecting.

34. A computer program product, comprising:
a computer storage medium; and
a computer program code mechanism embedded in the computer storage medium for causing a processor to replace a first service provider of one of a plurality of end-users of a common network with a second service provider, the first service provider and the second service provider providing services on the common network as customers of an operator of a high-speed network configured to provide connectivity between the plurality of end-users and both the first service provider and the second service provider, the computer program code mechanism having,
a first computer code device configured to maintain end-user information in a digital repository, the end-user information including a current service provider indicator for each of the plurality of end-users indicating a corresponding service provider providing services on the common network,
a second computer code device configured to store an indicator in a memory that the first service provider is no longer a customer of the operator of the high-speed network,
a third computer code device configured to access the digital repository and determine which of the plurality of end-users have a current service provider indicator indicating the first service provider,
a fourth computer code device configured to select the second service provider as a new service provider and to update the current service provider indicator for the one of the plurality of end-users in the digital repository to reflect the second service provider,
a fifth computer code device configured to direct each of the plurality of end-users identified by the third computer code device accessing the high-speed network to the fourth computer code device.

35. The computer program product of claim 34, wherein the digital repository comprises a database.

36. The computer program product of claim 34, wherein the high-speed network comprises a network dedicated to broadband data transport services.

37. The computer program product of claim 34, wherein the high-speed network comprises an open access network.

38. The computer program product of claim 34, wherein at least a portion of the common network comprises an Internet protocol network.

39. The computer program product of claim 34, wherein at least a portion of the common network comprises the Internet.

40. The computer program product of claim 34, wherein at least a portion of the high-speed network comprises at least one of a hybrid fiber optic coaxial network, a Digital Subscriber Line network, and a wireless broadband network.

41. The computer program product of claim 34, wherein at least one of the first service provider and the second service provider comprises an Internet service provider.

42. The computer program product of claim 34, wherein the fifth computer code device is further configured to direct each of the plurality of end-users to the fourth computer code device using a wildcard Domain Name System technique to resolve an end-user Domain Name System address resolution request to an IP address of the fourth computer code device.

43. The computer program product of claim 34, wherein the fifth computer code device is further configured to use at least one of a policy-based routing and a multi-protocol label switching based routing to direct each of the plurality of end-users to the fourth computer code device.

44. The computer program product of claim 34, wherein the fifth computer code device is further configured to use at least one of a tunneling technique a policy-based routing technique, and a multi-protocol label switching based routing technique to direct each of the plurality of end-users to the fourth computer code device.

45. The computer program product of claim 34, wherein:
the computer program code mechanism further includes
a sixth computer code device configured to
allocate a first subnet corresponding to the first service provider and a second subnet corresponding to the second service provider,
allocate a first IP address of the first subnet to a first device of a first end-user of the first service provider and a second IP address of the second subnet to a second device of a second end-user of the second service provider, and
renew IP addresses of to the first subnet and the second subnet at a predetermined period, wherein
the sixth computer code device does not renew IP addresses of the first subnet subsequent to the second computer code device storing the indicator in the memory.

46. The computer program product of claim 34, wherein the high-speed network comprises a network configured to provide at least one of Internet access, data services, digital video, analog video, packetized voice, voice-over-Internet Protocol, telephony services, interactive video, interactive television, near video-on-demand, and video-on-demand.

47. The computer program product of claim 34, wherein at least a portion of the high-speed network comprises a Data Over Cable Service Interface Specification network.

48. The computer program product of claim 34, wherein at least a portion of the high-speed network comprises a European Data Over Cable Service Interface Specification network.

49. The computer program product of claim 34, wherein at least a portion of the high-speed network comprises a Digital Subscriber Line network.

50. The computer program product of claim 34, wherein at least a portion of the high-speed network comprises a Point-to-Point Protocol over Ethernet network.

51. The system of claim 1, wherein the high-speed network comprises a network dedicated to broadband data transport services.

52. The system of claim 1, wherein the high-speed network comprises a network configured to provideat least one of Internet access, data services, digital video, analog video, packetized voice, voice-over-Internet Protocol, telephony services, interactive video, interactive television, near video-on-demand, and video-on-demand.

53. The system of claim 1, wherein at least a portion of the high-speed network comprises a Data Over Cable Service Interface Specification network.

54. The system of claim 1, wherein at least a portion of the high-speed network comprises a European Data Over Cable Service Interface Specification network.

55. The system of claim 1, wherein at least a portion of the high-speed network comprises a Digital Subscriber Line network.

56. The system of claim 1, wherein at least a portion of the high-speed network comprises a Point-to-Point Protocol over Ethernet network.

57. The method of claim 17, wherein the high-speed network comprises a network dedicated to broadband data transport services.

58. The method of claim 17, wherein the high-speed network comprises a network configured to provide at least one of Internet access, data services, digital video, analog video, packetized voice, voice-over-Internet Protocol, telephony services, interactive video, interactive television, near video-on-demand, and video-on-demand.

59. The method of claim 17, wherein at least a portion of the high-speed network comprises a Data Over Cable Service Interface Specification network.

60. The method of claim 17, wherein at least a portion of the high-speed network comprises a European Data Over Cable Service Interface Specification network.

61. The method of claim 17, wherein at least a portion of the high-speed network comprises a Digital Subscriber Line network.

62. The method of claim 17, wherein at least a portion of the high-speed network comprises a Point-to-Point Protocol over Ethernet network.

63. The system of claim 22, wherein the high-speed network comprises a network dedicated to broadband data transport services.

64. The system of claim 22, wherein the high-speed network comprises a network configured to provide at least one of Internet access, data services, digital video, analog video, packetized voice, voice-over-Internet Protocol, telephony services, interactive video, interactive television, near video-on-demand, and video-on-demand.

65. The system of claim 22, wherein at least a portion of the high-speed network comprises a Data Over Cable Service Interface Specification network.

66. The system of claim 22, wherein at least a portion of the high-speed network comprises a European Data Over Cable Service Interface Specification network.

67. The system of claim 22, wherein at least a portion of the high-speed network comprises a Digital Subscriber Line network.

68. The system of claim 22, wherein at least a portion of the high-speed network comprises a Point-to-Point Protocol over Ethernet network.
